(19) United States
(12) Patent Application Publication
(10) Pub. No.: US 2026/0284957 A1
(43) Pub. Date: Sep. 24, 2026

(54) METHOD AND HOT EMBOSSING DEVICE FOR DECORATING A NON-FLAT SURFACE OF A MAIN PART WITH A TRANSFER LAYER OF A HOT EMBOSSING FILM

(71) Applicant: LEONHARD KURZ Stiftung & Co. KG, Fürth (DE)

(72) Inventor: Sebastian ROAN, Fürth (DE)

(21) Appl. No.: 19/473,831

(22) PCT Filed: Apr. 2, 2024
(86) PCT No.: PCT/EP2024/058906

§ 371 Date: Oct. 9, 2025

(30) Foreign Application Priority Data
Apr. 11, 2023 (DE) 10 2023 109 102.6

(51) Int. Cl. B29C 51/08; B29C 51/26; B29C 51/42; B29C 51/44; B29C 63/00; B29C 63/02

(52) U.S. Cl. CPC B29C 51/082; B29C 51/262; B29C 51/42; B29C 51/44; B29C 63/0073; B29C 63/02

(57) ABSTRACT

Methods of decorating an uneven surface of a main body with a transfer ply of a hot stamping foil, wherein the following steps are performed:

providing the main body in a holding device;
providing the hot stamping foil;
clamping the hot stamping foil to a hot stamping die by means of a clamp device;
sucking the hot stamping foil onto a stamping face of the hot stamping die by means of vacuum suction;
preheating the hot stamping foil by means of heated hot stamping dies;
applying the transfer ply of the hot stamping foil to an uneven surface of the main body, in which the hot stamping foil is brought into contact with the uneven surface of the main body and the transfer ply is transferred to the main body by means of the hot stamping die under the effect of stamping pressure and stamping temperature.

The invention relates to a method and to a hot stamping device for decorating an uneven surface of a main body with a transfer ply of a hot stamping foil.

Conventionally, in a die stamping process, a hot stamping foil is applied to a surface of a main body or workpiece by means of a silicone die under predefined process parameters, such as stamping pressure, stamping temperature and stamping time. In the case of conventional 3D hot stamping operations, i.e. hot stamping operations in which a three-dimensional surface is to be decorated, a workpiece to be stamped is first positioned and fixed in a workpiece holder. The entire workpiece holder is then moved into stamping position. In addition, a clamping frame is used, which stretches the hot stamping foil across the workpiece surface to be stamped. Reduced pressure is conventionally used to suck the hot stamping foil onto the workpiece surface to be stamped, such that the hot stamping foil lies against the surface contour of the workpiece. The actual die stamping process is then carried out by means of a silicone die. However, such known processes tend to give unclean decoration results. Because the three-dimensional geometries are complex in some cases, the hot stamping foil is subject to severe distortions and compressions in order to adapt to the contour of the workpiece surface. This generally leads to wrinkles, which significantly impair the appearance of the stamping outcome.

For that reason, efforts have been made to preheat the hot stamping foil prior to stamping. A corresponding procedure is known, for example, from WO 2014/053381 A1. The hot stamping foil is preheated by means of a heated fan. However, a disadvantage of this method is that soil particles from the air are blown between the hot stamping foil and the stamping die by the fan. This leads to imprinting of the soil on the workpiece to be stamped and hence to reject material. Furthermore, the formation of wrinkles is not entirely avoidable by preheating by means of a heated fan, since the preheating of the hot stamping foil is generally uneven. A further disadvantage is an extended cycle time, since the preheating step has to be performed separately for a predefined period of time.

It an object of the invention to improve the decorating of uneven surfaces, in particular three-dimensional surfaces, by means of hot stamping in that wrinkling in the stamping area is to be avoided and larger areas are to be decoratable without wrinkling.

The object is achieved by a method of decorating an uneven surface of a main body with a transfer ply of a hot stamping foil, wherein the following steps are performed, in particular in the following sequence:
providing the main body in a holding device;
providing the hot stamping foil;
clamping the hot stamping foil to a hot stamping die by means of a clamp device;
sucking the hot stamping foil onto a stamping face of the hot stamping die by means of vacuum suction;
preheating the hot stamping foil, in particular at least in the region of the stamping face and/or in the region of a three-dimensional foil guide which is preferably adjacent to the stamping face, by means of heated hot stamping dies;
applying the transfer ply of the hot stamping foil to an uneven surface of the main body, in which the hot stamping foil is brought into contact with the uneven surface of the main body and the transfer ply is transferred to the main body by means of the hot stamping die under the effect of stamping pressure and stamping temperature.

It is preferably the case that the hot stamping die is preheated even before the suction of the hot stamping foil. In particular, the hot stamping foil is then preheated even after the hot stamping foil has been clamped, since the hot stamping foil is already in close proximity to the hot stamping die and can be preheated by radiative heat.

This object is further achieved by a hot stamping device for decorating an uneven surface of a main body with a transfer ply of a hot stamping foil, in particular by a method as claimed in any of claims 1 to 27, wherein the hot stamping device comprises a holding device for holding the main body and a hot stamping die with a stamping face for applying the transfer ply of the hot stamping foil to the main body and a clamp device for clamping the hot stamping foil to the hot stamping die. It is essential that the hot stamping device has a vacuum suction for sucking the hot stamping foil onto the stamping face of the hot stamping die, where the vacuum suction is connected to the hot stamping die, and that the heated hot stamping die preheats the sucked-on hot stamping foil, in particular at least in the region of the stamping face and or in the region of a three-dimensional foil guide which is preferably adjacent to the stamping face.

It has been shown that, by the inventive method of decorating an uneven surface of a main body with a transfer ply of a hot stamping foil and the hot stamping device for decorating an uneven surface of a main body with a transfer ply of a hot stamping foil, a stamped main body is obtained, the decoration of which is clean and wrinkle-free. What is meant by “clean” in this case is that the stamping contours are pin-sharp. Furthermore, the suction of the hot stamping foil onto the stamping face of the preferably heated or hot stamping die results in “automatic” preheating of the hot stamping foil, as a result of which it is firstly possible to dispense with any additional heat source for preheating, and wrinkle-free application is secondly promoted.

Further advantageous configurations of the invention are described in the subsidiary claims.

Preferably, the main body is a rigid body which in particular has at least one uneven surface to be decorated.

It is possible in particular that the uneven surface of the main body, in particular the surface of the main body to be decorated or stamped is 2.5D-shaped or three-dimensionally (3D) formed or shaped.

Preferably, the main body comprises a component, in particular a vehicle part, a housing part, a cockpit component and/or a bodywork part, an injection-molded part, a 3D-printed part and/or a component produced by a machining and/or nonmachining production method. In general, the main body provided may be any body having at least one stampable surface. Stampable surfaces are surfaces that firstly have sufficient adhesion for a thermally activatable layer, in particular the thermally activatable adhesive, of the hot stamping foil and secondly are of sufficient mechanic stability that they can withstand the process parameters of hot stamping, such as temperature and pressure.

Advantageously, the main body comprises a plastic material comprising a thermoplastic, in particular an impact-resistant thermoplastic. Moreover, the plastic material consists in particular of polyethylene (PE), polycarbonate (PC), polypropylene (PP), polystyrene (PS), polybutadiene, polynitriles, polyesters, polyurethanes, polymethacrylates, polyacrylates, polyamides, polyethylene terephthalate (PET), polybutylene terephthalate (PBT), preferably acrylonitrile-butadiene-styrene (ABS), acrylonitrile-styrene-acrylonitrile (ASA), ABS-PC, PET-PC, PBT-PC, PC-PBT and/or ASA-PC and/or copolymers or mixtures thereof. It is also possible that the plastic material also includes inorganic or organic fillers, preferably SiO₂, Al₂O₃, TiO₂, clay minerals, silicates, zeolites, glass fibers, carbon fibers, glass beads, organic fibers or mixtures thereof. The fillers are mixed in particular into the plastic material in order to further increase the stability of the main body. Moreover, these fillers can reduce the proportion of polymeric materials and hence reduce production costs and/or the weight of the component. It is also possible that the plastic material still includes inorganic or organic auxiliaries, which in particular improve the processibility of the plastic material.

It is also possible that the material of the main body comprises steel, copper, brass and/or other metallic materials and/or alloys. It is also possible that the material of the main body comprises glass and/or wood.

It is also possible that the main body is already decorated and is to be augmented with a further decoration. For example, the main body may already have been decorated by means of digital printing and/or in-mold decoration (IMD) and/or insert molding and/or another stamping operation. In particular, paint layers and/or varnish layers and/or foil packages and/or transfer plies have already been applied to the main body. Preferably, these decorations are decorations that have been applied to a flat surface of the main body. In combination with the method of the invention, a variety of decorations can thus be achieved.

Although it is preferably the case that the main body may already be decorated by an IMD process, it is possible according to the present invention that this main body decorated by IMD processes is additionally decorated by hot stamping. However, the present invention is to explicitly exclude IMD methods. This means that the described method of decorating an uneven surface of a main body with a transfer ply of a hot stamping foil and the described hot stamping device for decorating an uneven surface of a main body with a transfer ply of a hot stamping foil relates to decoration by hot stamping. Such a hot stamping operation preferably differs from an IMD process in that a finished main body or a finished injection-molded part is already additionally being stamped after injection molding. In contrast, in the IMD process, an IMD transfer foil is inserted into an injection mold half and then subjected to in-mold coating with a plastic material to form an injection-molded part decorated with the transfer ply of the IMD transfer foil.

A “hot stamping die” refers to a heated or warmed stamping die.

It is preferably possible that the hot stamping foil has a carrier ply and a transfer ply detachable from the carrier ply.

It may also be the case that there is at least one release layer between the carrier ply and the transfer ply.

It is preferably the case that the at least one release layer comprises at least one material or a combination of materials selected from: wax, carnauba wax, montanic esters, polyethylene wax, polyamide wax, PTFE wax, silicone, melamine-formaldehyde resin.

The at least one release layer is preferably a polymeric release layer, which have better and/or different detachment characteristics than conventional carrier plies. Such release layers are irreversibly bonded to the carrier ply and a transfer ply is disposed on the release layer. The transfer ply can be more easily detached from the carrier ply, in particular with a polymeric release layer, such that higher-quality decoration of the main body is achieved.

The transfer ply may take the form of a multilayer body formed from several layers. In particular, the transfer ply has at least one layer or a combination of layers selected from: adhesive layer, release layer, decoration layer, metal layer, oxide layer, electrically conductive layer, semiconductor layer, reflection layer, carbon black layer, adhesion promoter layer, primer layer, barrier layer, paint layer, protective layer, functional layer.

The protective layer may take the form of a protective coating of a PMMA-based varnish having preferably a layer thickness in the range from 0.5 μm to 5 μm, in particular in the range from 2 μm to 4 μm. The choice of such a layer thickness ensures that there is firstly corresponding protection and secondly further processibility of the hot stamping foil, and there is no delamination at the interface of the protective coating layer and the other layers of the transfer ply or the decoration layer. This also improves the resistance of the decorated main body to mechanical and/or physical and/or chemical environmental influences.

The protective varnish or protective layer may also consist of a radiation-curing dual cure varnish. This dual cure varnish can be thermally precrosslinked in a first step during and/or after application in liquid form and free-radically post-crosslinked in a second step after the processing of the hot stamping foil, in particular via high-energy radiation, preferably UV radiation. Dual cure varnishes of this type may consist of various polymers or oligomers that have unsaturated acrylate or methacrylate groups. These functional groups may be free-radically crosslinked with one another in the second step mentioned above. For thermal precrosslinking in the first step, at least two or more alcohol groups must also be present in these polymers or oligomers. These alcohol groups may be crosslinked with multifunctional isocyanates or melamine-formaldehyde resins. Useful unsaturated polymers or oligomers may be various UV raw materials such as epoxy acrylates, polyether acrylates, polyester acrylates and in particular acrylates. Useful isocyanates may be either blocked or unblocked representatives based on TDI (TDI=toluene 2,4-diisocyanate), HDI (HDI=hexamethylene diisocyanate) or IPDI (IPDI=isophorone diisocyanate). The melamine crosslinkers may be fully etherified versions, may be imino types, or are benzoguanamine representatives.

It may also be the case that the protective layer takes the form of a protective coating of a PMMA-based (PMMA=polymethylmethacrylate) varnish or a varnish based on a mixture of PVDF (PVDF=polyvinylidene fluoride) and PMMA, having preferably a layer thickness in the range from 2 μm to 50 μm, preferably in the range from 5 μm to 30 μm. These varnishes provide the necessary mechanical brittleness for a hot stamping foil and sufficiently accurate formability or separability thereof at the desired outer limits of the transferred surface regions of the transfer plies.

The decoration layer may take the form of a or single-layer or multilayer decoration layer. This decoration layer preferably comprises one or more layers.

The decoration layer may preferably include one or more paint layers, in particular color paint layers. These paint layers may be colored differently and/or transparent and/or semitransparent and/or opaque, and may also be separated by one or more further layers, in particular transparent layers. The paint layers may each be present over the full area or only partially in their layer plane. The paint layers are preferably applied by known printing methods selected from: intaglio printing, screen printing, offset printing, inkjet printing, pad printing, xerographic printing or combinations thereof. The paint layers may consist of a binder and colorant and/or fillers and/or pigments, in particular also optically variable pigments and/or interference layer pigments and/or liquid-crystal pigments and/or magnetically alignable pigments and/or thermochromic pigments and/or metallic pigments. Furthermore, the paint layer may also include phosphorescent and/or luminescent dyes.

Moreover, the decoration layer may also comprise one or more reflection layers that are preferably opaque, translucent and/or partial. In particular, the reflection layers may consist of metals and/or HRI layers (HRI=high refractive index), i.e. layers with a high refractive index, in particular with a refractive index greater than 1.5. Examples of useful metals include aluminum, tin, indium, chromium or copper or alloys thereof. Useful HRI layers include, for example, ZnS or SiO₂.

Moreover, the decoration layer may also have one or more optically active relief structures, in particular diffractive structures and/or holograms and/or refractive structures and/or matte structures. There is preferably at least one reflection layer disposed directly on the relief structure at least in some regions.

In the case of a metal layer, it is advantageous to apply this metal layer by evaporation, physical vapor deposition (PVD) and/or chemical vapor deposition (CVD) and/or sputtering. Different decorative layers may also consist of different metals and in particular different-colored metals.

Metal layers are preferably applied to a clearcoat layer or to a pigment-containing varnish layer. It is then advantageous to apply an additional coating layer to the metal layer as a metal adhesion-promoting layer in order to improve the adhesion of layers that build thereon.

The layers of the transfer ply, in particular the decoration layer, may each be present over the full area or each only in part. If several layers of the transfer ply, in particular decorative layers, are each present in part, individual elements in the layers of the transfer ply may be positioned alongside one another, in particular directly alongside one another, or so as to overlap at least in some regions. It is also possible that a part-layer of the transfer ply is positioned atop a full-area layer of the transfer ply, where the full-area layer of the transfer ply serves as a background or substrate for the part-layer of the transfer ply, which forms a contrast in particular to the part-layer of the transfer ply in color and/or in brightness and/or reflectivity and/or roughness.

It is also possible that the main body forms part of the resulting decoration by combining the color and/or the brightness and/or the reflectivity and/or the roughness of the main body with the layers of the transfer ply thereon, in particular decorative layers. The main body may be transparent and/or semitransparent and/or translucent and/or opaque and/or have coloring with dyes and/or pigments. In particular, the main body forms a background or substrate for the layers of the transfer ply, in particular decorative layers, which preferably forms a contrast to the layers of the transfer ply, in particular decorative layers, in color and/or in brightness and/or reflectivity and/or roughness.

The elements of the layers of the transfer ply may be offset from one another in top view of the transfer ply or in an overlapping arrangement. However, the elements may also be arranged alongside one another in the top view of the transfer ply. The elements, especially the decoration layer, may also form one or more motifs. For example, a motif may include a graphic outline, a figurative representation, an image, a visually recognizable design element, a symbol, a logo, a portrait, a pattern, an infinite pattern, an alphanumeric character, a codification, a code pattern, a cryptographic pattern, a text, a color scheme and the like. The motif may also be individualized.

What is meant by individualized is in particular that the print includes information that is unique to each print, for example unique serial numbers. What is meant by individualized is in particular also that the print includes information that is identical for a group of prints but unique for each group of prints, for example a batch number. Where printing is referred to hereinafter, this can mean an individualized print or a non-individualized print.

Advantageously, the elements of the layers of the transfer ply are arranged such that at least some of the elements or parts of some elements form an overall motif in the top view of the transfer ply. One or more of these elements may be individualized or non-individualized. For example, one or more non-individualized elements may complement one or more individualized elements to form an overall motif. In particular, the prints may be arranged in register to one another.

Register or registration accuracy means positional accuracy of two or more elements and/or layers relative to one another. Registration accuracy should be within a defined tolerance and be as low as possible. At the same time, the registration accuracy of multiple elements and/or layers relative to one another is an important feature in order to increase process reliability. Exact positioning can be effected in particular by means of sensory, preferably optically detectable, registration marks.

These registration marks may either constitute special separate elements or regions or layers, or they may themselves be part of the elements or regions or layers to be positioned.

It may also be the case that one or more transparent or translucent or transparently or translucently colored spacer layers with a thickness of, for example, 0.5 μm to 10 μm are arranged between two part-layers of the transfer ply, in particular decorative layers, with elements or decorative elements or between a part-layer of the transfer ply, in particular decoration layer, with elements or decorative elements and a full-area layer of the transfer ply, in particular decoration layer, in order to create a three-dimensional depth effect of the decoration. It is also possible that the main body constitutes such a spacer layer or performs the function of such a spacer layer.

In particular, shading and/or concealment effects of the elements or decoration elements can be achieved, in particular depending on the illumination angle and/or viewing angle of the decorative layers.

In the case of a varnish layer with a surface relief used for molding, the surface relief used may advantageously be an optically effective surface relief. The surface relief may be a surface relief which forms an optically active and hence refractive structure and thus generates in particular a macroscopic visually detectable and/or tactile motif. Moreover, it is also possible that the surface relief is a matte structure which, for example, generates the visual impression of a matte metallic surface in combination with a corresponding metal layer in the decoration layer structure.

Moreover, it is also possible that the surface relief is a surface relief which forms lens structures and/or microlens structures and/or free-form surface structures, which may give a further three-dimensional impression of a motif. It is also possible that the surface relief used is diffractive structures, such as holograms or the like. However, it is also possible that the surface relief used for molding is a surface relief detectable only by touch, which, for example, simulates a wooden decoration or the like.

It is preferably the case that the at least one paint layer is formed from a PMMA-based varnish with preferably a layer thickness in the range from 0.5 μm to 10 μm.

It is preferably the case that the primer has an adhesive layer and/or adhesion-promoting layer. It may be the case that the primer layer is formed with a layer thickness in the range from 1 μm to 5 μm. Useful priming materials include PMMA, PVC, polyesters, polyurethanes, chlorinated polyolefins, polypropylene, epoxy resins or polyurethane polyols in combination with inactivated isocyanates. The primer layer may also include inorganic fillers.

Preferably, the hot stamping foil, in particular the transfer ply, has, on the side of the hot stamping foil facing away from the carrier ply, a thermally activatable adhesive layer that can be activated in particular by the thermal energy of the hot stamping die. After application, the carrier ply is removed with the parts of the transfer ply that have not been applied with the hot stamping die.

Preferably, the hot stamping foil, in particular the transfer ply, has a single image and/or an infinite pattern. It may also be the case that the hot stamping foil, in particular the transfer ply, forms a monochrome surface. It may also be the case that the hot stamping foil, in particular the transfer ply, forms a transparent or translucent surface without an optically recognizable single image and/or infinite pattern.

In particular, the hot stamping foil, in particular the carrier ply and/or the transfer ply, is biodegradable and/or compostable.

What is meant here by “biodegradable” is that a material degrades to an extent of more than 90%, in particular to an extent of more than 95%, to water and/or carbon dioxide and/or biomass in the presence of microorganisms or fungi after a predefined period of time under defined temperature, air and humidity conditions. Preferably, biodegradable and/or compostable materials include a material and/or a material combination selected from: starch, starch derivatives, cellulose, cellulose derivatives, lignin, polylactides (PLA), polyhydroxyl fatty acids (PHB and/or PHV), chitin, chitosan, proteins, casein, gelatin, degradable polyester (PE).

It is also possible that the carrier ply includes a material or a combination of materials selected from: PET, PMMA, PC, PE, PVC, ABS, PU, PBS, TPU, PP, PLA, PEF and/or PAN.

In particular, depending on the geometry and material of the main body, different holding devices are used, which are in particular individually adapted to the respective main body, preferably adapted in such a way that the holding device fixes the respective main body in a form-fitting and/or force-fitting manner. In this case, the clamping force of the holding device is chosen so as to rule out distortion and/or deformation of the main body owing to the clamping force.

Moreover, it may also be the case that the holding device has an indentation which corresponds essentially to the negative of the main body, preferably where there is an excess relative to the main body. This allows the main body to be easily inserted into the indentation of the holding device.

It may also be the case that the holding device has a step in which the main body is held, in particular where the step corresponds at least to the height of the clamp device. Such a step prevents collision between clamp device, which moves vertically together with the hot stamping die, and the holding device on application of the hot stamping foil. In this regard, it is further preferably the case that the step has smaller dimensions than the recess in the clamp device, in particular as described further down. The step preferably forms an elevation for the main body holder relative to the remainder of the base of the holding device.

It is also the case in particular that the holding device is openable and/or closable mechanically and/or hydraulically and/or pneumatically and/or electromechanically and/or manually.

It is additionally also possible that the procedure includes the following step:
feeding and/or positioning the main body in the holding device.

The main body is preferably fed and/or positioned by human hand and/or by a conveyor device that ends in the holding device, and/or in a fully automated manner, for example by a robot, in particular robot arm.

It is preferably possible that the holding device is movable, in particular horizontally movable, between a removal position and a processing position and/or is movable, in particular horizontally movable, between an insertion position and the processing position. This is advantageously accomplished by means of a mechanical and/or pneumatic and/or hydraulic and/or electromechanical drive. Removal position refers to the position at which the decorated main body is removed from the holding device. Insertion position refers to the position at which the main body to be decorated or stamped is inserted into the holding device. In an advantageous configuration, the removal position and the insertion position may be identical. However, it is also possible, especially when several holding devices are provided, that the removal position and insertion position are at different sites. For example, a main body to be decorated can be inserted into a further holding device simultaneously with the removal of a decorated main body from a holding device. It is also possible that a further main body is being decorated or stamped in another holding device at the same time. Thus, the cycle time can be considerably shortened and the throughput can be increased accordingly.

It is additionally also possible that the holding device is movable, in particular vertically movable, between the processing position and a stamping position, preferably by means of a mechanical and/or pneumatic and/or hydraulic and/or electromechanical drive, where the holding device in the stamping position is moved or pressed onto the hot stamping die under the effect of stamping pressure. In this scenario, the hot stamping die is rigid, i.e. is not moved. Instead, the holding device moves toward the hot stamping die. Stamping position thus means the position in which the uneven surface of the main body comes into contact with the stamping face of the hot stamping die or the hot stamping foil as a result of the moving of the holding device. This configuration is an advantageous option particularly when comparatively small main bodies are to be decorated. In this case, the corresponding holding devices are smaller and lighter than the hot stamping die. The moving of the lighter holding device thus consumes less energy.

Furthermore, it is preferably the case that the holding device is moved into the processing position or into the stamping position.

It is preferably the case that the hot stamping foil is supplied between the clamp device and the hot stamping die, in particular by means of a roll-to-roll process or as a foil sheet. The feeding of the hot stamping foil may overlap in time with the movement of the holding device into the processing position or into the stamping position. This can reduce cycle time and accordingly also increase throughput.

It is preferably possible that the hot stamping device has a feed device that feeds the hot stamping foil between the hot stamping die and the clamp device in a roll-to-roll process or as a foil sheet.

It is further possible that the feed device has an unwinding roller for unwinding the hot stamping foil and a winding roller for winding the hot stamping foil, where the hot stamping foil is inserted and ejected between the hot stamping die and the clamp device. The advantage over use of foil sheets or sheets is in particular that setup times are reduced.

It is conceivable that the hot stamping die is movable, preferably vertically movable, between a starting position and a stamping position, preferably by means of a mechanical and/or pneumatic and/or hydraulic and/or electromechanical drive, in particular where the hot stamping die in the stamping position is moved or pressed onto the main body under the effect of stamping pressure. This configuration is an advantageous option particularly when comparatively large main bodies are to be decorated. In particular, in this case, the hot stamping die is smaller and lighter than the holding device. The moving of the lighter hot stamping die compared to the holding device thus consumes less energy.

It is preferably the case that the stamping face of the hot stamping die corresponds to the stamping region to be stamped on the uneven surface of the main body.

The uneven surface of the main body is preferably decorated by die stamping.

Advantageously, the hot stamping die has a foil contact face that surrounds the stamping face on all sides. It is preferably the case that the hot stamping foil runs between foil contact face of the hot stamping die and the clamp device or a sealing lip of the clamp device and/or a sealing lip of the hot stamping die. In other words, this means that the hot stamping foil is preferably clamped between the foil contact face of the hot stamping die or the sealing lip of the hot stamping die and the clamp device or the sealing lip of the clamp device. It is preferably the case that the foil contact face corresponds to a flat shape or a cylindrical shape or a 2.5D shape.

Cylindrical and 2.5D shapes mean faces that are curved about an axis. Furthermore, it is preferably the case that the opposite foil contact faces are always in the same plane or at the same height. This is true longitudinally and transverse to foil direction. However, it is also conceivable that the opposite foil contact faces are in different planes or at different heights. Preferably, foil direction means the direction in which the foil is guided between the hot stamping die and the clamp device, in particular by roll-to-roll movement. Foil direction corresponds to the longitudinal direction or longitudinal extent of the foil sheet between the unrolling (feed) and rolling (discharge) of the foil. The length of the foil sheet in foil direction is therefore greater than the width of the foil sheet transverse to foil direction.

In particular, it is possible that the hot stamping die, between the foil contact face and the stamping face, has a three-dimensional foil guide in the form of intake slopes, where the intake slopes are at an angle of not more than 40°, preferably not more than 35°, more preferably not more than 30°. Such flat angles ensure that the hot stamping foil is not unnecessarily “stressed” in the region of the intake slopes. This means that the hot stamping foil is subject to little distortion, compression and/or stretching. Another effect is that this advantageously achieves a reserve of the hot stamping foil for the decoration region or the stamping face. This reserve is preferably necessary so that the hot stamping foil can adapt to the contours of the stamping face which in some cases are at significant angles of up to 60°, and sufficient foil material is still available for this adjustment.

Preferably, the hot stamping die has a stamping cavity which is or has been formed in particular from the stamping face and/or the three-dimensional foil guide in the form of an intake slope and/or the foil contact face. The embossing cavity means the “cavity” formed by the hot stamping die, which in particular corresponds essentially to the contour of the uneven surface of the main body.

Preferably, the hot stamping die has surface regions adjacent to the stamping cavity. In particular, the angle of all surface regions adjacent to the stamping cavity is at an angle of not more than 40°, preferably of not more than 35°, more preferably of not more than 30°.

In particular, the hot stamping die has a stamping face within the stamping cavity.

This stamping face preferably corresponds to the decoration region. Furthermore, it is preferably the case that the angle of all surface regions within the stamping face and/or the decoration region is at an angle of not more than 60°, preferably of not more than 50°, more preferably of not more than 45°. Such angles ensure that the hot stamping die is able to apply the stamping pressure required for application in vertical direction. In the case of more inclined surfaces, the stamping pressure would decrease to such an extent that application of the transfer ply of the hot stamping foil would no longer be possible and/or there may be wrinkling in the hot stamping foil.

In particular, a clamping plane is or has been formed between the foil contact face and the surface of the clamp device.

It is additionally also possible that the foil contact face, in particular the clamping plane, is at a vertical distance from the top end of the stamping face of at least 2 mm in a plane of intersection of the hot stamping die.

Furthermore, it is also possible that the maximum permissible angle between the top end of the stamping face and the three-dimensional foil guide or the intake slope is not more than 40°.

Preferably, when the hot stamping die is viewed in a plane of intersection, the horizontal distance between the outermost point on the three-dimensional foil guide or the intake slope and the top end of the stamping face is at least 10 mm. The outermost point on the three-dimensional foil guide or the intake slope means the point at which the three-dimensional foil guide or the intake slope merges into the foil contact face.

In particular, it is appropriate that the hot stamping die has at least one direct heater for rapid heating of the hot stamping die. The hot stamping die here has heating wires, preferably with the resultant benefit that energy is saved. Alternatively, the hot stamping die may also be in two-part form, in which it has a heating plate and a stamping plate mountable on the heating plate. It is preferably the case that the heating region of the hot stamping die is between 0° C. and 300° C., in particular between 80° C. and 250° C.

It is preferably the case that the hot stamping die and/or a stamping face of the hot stamping die comprise a material or a material combination selected from: steel, silicone, plastic, aluminum, copper, brass, magnesium. Alternatively, the hot stamping die and/or the stamping face of the hot stamping die may also have been produced from alternative metals, for example by 3D printing.

Preferably, the material or the material combination of the stamping face has a Shore A hardness between 30 and 90, more preferably between 50 and 90.

It is also possible that the clamp device has a sealing lip. It is alternatively or additionally possible that the hot stamping die has a sealing lip. The hot stamping foil is preferably clamped between the sealing lip of the clamp device and the foil contact face of the hot stamping die and/or the hot stamping foil is preferably clamped between the sealing lip of the hot stamping die and the foil contact face of the clamp device. If the clamp device has a sealing lip, it is preferably the case that the sealing lip on the clamp device is formed correspondingly to the contour of the foil contact face of the hot stamping die. If the hot stamping die has a sealing lip, it is preferably the case that the sealing lip is formed on the hot stamping die corresponding to the contour of the foil contact face on the clamp device.

The surface corresponding to the sealing lip on the hot stamping die or on the clamp device may continue through a groove or bulge opposite the sealing lip, where the hot stamping foil on clamping is fixed between the sealing lip and the groove or bulge. It is preferably the case that the hot stamping die or the clamp device has a groove corresponding to the sealing lip or a bulge corresponding to the sealing lip, in particular where the groove or bulge is formed according to the contour of the sealing lip.

It is preferably the case that the chosen width of the groove or bulge corresponding to the sealing lip is less than the maximum width of the sealing lip. It is advantageously also the case that the chosen depth of the groove or bulge corresponding to the sealing lip is greater than the height of the sealing lip protruding from the component fixing the sealing lip. The component fixing the sealing lip means that component in which the sealing lip is fixedly positioned. This may be either the hot stamping die or the clamp device. What is meant by the protruding height of the sealing lip is the height calculated from the footprint of the component that fixes the sealing lip and the highest point of the sealing lip protruding from that footprint. If the sealing lip is within the hot stamping die, the footprint is the foil contact face. If the sealing lip is within the clamp device, the footprint is the surface of the clamp device facing the hot stamping die.

Furthermore, it is preferably the case that the groove or the bulge has two flanks each, in particular arranged opposite one another. Advantageously, the sealing lip comes into contact with at least one flank on clamping, preferably both opposite flanks of the groove or bulge.

The material characteristics of the sealing lip preferably correspond to the material properties of the stamping face of the hot stamping die, especially when the sealing lip is arranged on the hot stamping die. The material characteristics of the sealing lip are preferably chosen such that it is possible to achieve a sealing effect with the surface corresponding to the sealing lip, in particular with the flank or the flanks of the groove or bulge, on the hot stamping die or on the clamp device. In particular, the sealing lip includes a material or a material combination selected from: steel, silicone, plastic, aluminum, copper, brass, magnesium. In particular, the groove or bulge includes a material or a material combination selected from: steel, silicone, plastic, aluminum, copper, brass, magnesium. The sealing lip in conjunction with the groove or bulge advantageously ensures that the hot stamping foil cannot slip after clamping. This means that the sealing lip can additionally assist the vacuum suction of the hot stamping die, which likewise fixes the hot stamping foil in one position, in the fixing of the hot stamping foil.

Preferably, the material or the material combination of the sealing lip has a Shore A hardness between 30 and 90, more preferably between 50 and 90.

It is advantageously possible that the shape of the surface of the clamp device facing the hot stamping die essentially corresponds to a negative of the surface of the hot stamping die, in particular the foil contact face of the hot stamping die. It is thus preferably the case that the sealing lip corresponds to a flat shape or a cylindrical shape or a 2.5D shape, in particular corresponding to the foil contact face of the hot stamping die and/or the clamp device.

It is additionally also possible that the clamp device takes the form of a continuous frame with a recess larger than the main body or takes the form of two opposing clamping blocks with a distance greater than at least one lateral dimension of the uneven surface of the main body. In the die stamping by the hot stamping die, this prevents collision between the clamp device on the hot stamping die and the main body or the holding device.

It is appropriately possible that the clamp device for clamping the hot stamping foil between hot stamping foil and clamp device is designed such that the hot stamping foil is clamped between the foil contact face of the hot stamping die and the sealing lip of the clamp device or between the foil contact face of the hot stamping die and the surface of the clamp device. In the case that a sealing lip is present on the hot stamping foil, it is also possible that the clamp device for clamping the hot stamping foil between hot stamping foil and clamp device is designed such that the hot stamping foil is clamped between the sealing lip of the hot stamping die and the surface of the clamp device or between the sealing lip of the hot stamping die and the sealing lip of the clamp device.

It is additionally also possible that the hot stamping foil is clamped in such a way that the hot stamping foil is at at least a vertical distance of 2 mm from the top end of the stamping face of the hot stamping die in the clamped state. This ensures that the hot stamping foil does not touch the heated stamping face of the hot stamping die during the clamping operation. Such premature contact of the stamping face with the hot stamping foil prior to the actual stamping operation would adversely affect the local stamping properties of the hot stamping foil, for example locally deform and/or locally activate the adhesive.

Advantageously, the clamping is effected by moving the clamp device toward the hot stamping die. It is preferably the case that the clamp device is individually controllable.

The guides for the clamp device may be positioned on the holding device. In particular, the clamp device in this case completely embraces the outer contour of the main body. Alternatively, the guides for the clamp device may be positioned on the hot stamping die. In particular, the clamp device in this case embraces the outer contour of the region of the main body to be stamped. This may be advantageous for applications with a region to be stamped that is smaller than the outer contour of the main body, especially in the case of very large main bodies.

It is in particular the case that the hot stamping device has a compressed air device for releasing the hot stamping foil from the hot stamping die by means of compressed air. It is preferably the case that, after the stamping time has elapsed, the hot stamping die is lifted off the main body. Advantageously, the hot stamping foil is to remain on the main body after application for a predetermined cooling time, in particular wherein the cooling time is 1s to 5s. However, in order that the hot stamping die can lift off without damaging the heated and therefore mechanically unstable hot stamping foil, the hot stamping foil is detached from the surface of the hot stamping die by means of the compressed air unit. This can preferably be done before the hot stamping die is lifted off or during the lifting of the hot stamping die.

The cooling can enable the hot stamping foil to regain strength and mechanical stability, such that the carrier ply can be faultlessly detached in the subsequent step from the transfer ply of the hot stamping foil applied to the main body, with the transfer ply of the hot stamping foil remaining on the main body in the region of the stamping face or in the decoration region. The cooling and in particular resultant mechanical stabilization of the carrier ply and transfer ply of the hot stamping foil also improves the edge decoration of the main body by the transfer ply and thus enables a cleaner breakaway in the layer composite of the transfer ply, since the cooled transfer ply has a mechanical stable bond to the main body.

It is also advantageous when the compressed air device detaches the hot stamping foil from the hot stamping die at a pressure in the range from 1.05 bar to 2 bar.

In particular, it may also be the case that the hot stamping die has at least one channel and/or at least one bore, in particular several bores, which are connected to the vacuum suction and/or the compressed air device via at least one connection. The channel is preferably a collecting channel which connects all the bores to one another. The bores are preferably designed so that they reach the surface of the hot stamping die. The bores can extend, for example, over the foil contact face and/or the three-dimensional foil guide or intake slopes. The bores may be arranged at regular or irregular intervals. Advantageously, the number of bores is chosen such that the stamping face enables very good decoration, and at the same time the hot stamping foil is sucked onto the surface of the stamping face by means of reduced pressure, to a sufficient degree that it adapts to the stamping face, in particular in a wrinkle-free manner and/or without trapped air. Wrinkle-free adaptation is advantageously important in order to enable a high accuracy and quality of the decoration.

Preferably, both the vacuum suction and the compressed air device are connected to the channel and/or the bores via a connection. This means that both the vacuum suction and the compressed air device use the channel and the bores of the hot stamping die to suck in or detach the hot stamping foil.

It is also possible that the vacuum suction sucks the hot stamping foil onto the stamping face of the hot stamping die at a pressure in the range from 0.05 bar to 0.95 bar, preferably from 0.1 bar to 0.8 bar.

It is advantageously the case that the hot stamping die preheats the hot stamping foil, in particular in the region of the stamping face, for a period of time in the range from 1 s to 10 s, in particular in the range from 1 s to 5 s.

Preferably, the hot stamping foil is stretchable as a result of the preheating. This allows the hot stamping foil to adapt better and more accurately to the stamping face of the hot stamping die. This promotes high-quality and wrinkle-free decoration of the main body. The preheating is preferably effected before and/or during and/or after the suction of the hot stamping foil onto the surface of the hot stamping die.

The preheating is advantageously accomplished using the intrinsic heat of the hot stamping die. This means that other heat sources can be dispensed with, which firstly reduces design complexity and is secondly also energy-efficient. This also offers the advantage that the hot stamping foil is preheated evenly over its whole area.

It is further possible that applying of the hot stamping foil to the uneven surface of the main body is accomplished by moving the hot stamping dies toward the holding device and/or moving the holding device toward the hot stamping die such that the hot stamping foil comes into contact with the uneven surface of the main body. In particular, the hot stamping die moves together with the clamp device. In particular, it is irrelevant whether the guides for the clamp device are positioned on the holding device or on the hot stamping die.

It is additionally also possible that, on application, the hot stamping foil is brought into contact with the uneven surface of the main body in that the hot stamping die moves or is moved onto the main body and/or the holding device moves or is moved toward the hot stamping die. In particular, the hot stamping die is moved from a starting position to a stamping position or the clamp device is moved from a processing position to a stamping position. Stamping position means the position in which contact is or has been established between the uneven surface of the main body with the hot stamping foil adjacent to the stamping face of the hot stamping die. It may also be the case that the applying of the hot stamping foil involves leaving the hot stamping die on the uneven surface of the main body for a stamping time of 0.5 second to 5 seconds, in particular from 0.5 second to 1.5 seconds.

It is additionally also possible that the hot stamping foil is applied at a stamping temperature in the range from 150° C. to 250° C., in particular in the range from 180° C. to 220° C. Furthermore, the hot stamping foil can be applied with a stamping pressure in the range from 200 N/cm² to 370N/cm² , preferably in the range from 250 N/cm² to 300N/cm^{2 .}

It is also possible that the applying of the hot stamping foil is effected at a stamping temperature in the range from 150° C. to 250° C., in particular in the range from 180° C. to 220° C. It is further preferably the case that the decorating of the hot stamping foil is effected with a stamping pressure in the range from 200 N/cm² to 370N/cm² , preferably in the range from 250 N/cm² to 300N/cm².

It is advantageously the case that the hot stamping die is moved into the starting position after the applying and/or the holding device is moved into the processing position after the applying.

It is preferably also the case that, before and/or during the moving of the hot stamping die into the starting position, the hot stamping foil is blown away from the hot stamping die by means of a compressed air device, preferably under positive pressure. As a result, the soft and mechanically unstable hot stamping foil becomes faultlessly detached from the surface of the hot stamping die while it is moving and/or before it moves to its starting position. It is thus possible to prevent cracks in the decoration.

Preferably, the hot stamping die is moved independently of the clamp device or the clamp device is moved together with the holding device. This means that, after the applying, either the hot stamping die moves alone or the holding device and the clamp device move together, such that the applied hot stamping foil can first cool down. Preferably, the clamp device is lifted or moved only after the cooling time has been attained.

In particular, it is possible that, after the applying, in particular after the stamping time has elapsed, more preferably after the hot stamping die has been moved into the starting position, the hot stamping foil remains on the main body for a cooling time within a range from 1 second to 5 seconds. Such a cooling time causes the hot stamping foil to regain strength and mechanical stability. This mechanical stability then ensures successful and faultless detachment of the hot stamping foil or the carrier ply in the decoration region from the transfer ply applied to the main body.

It is preferably the case that the clamp device is liftable and lowerable in horizontal direction for detaching of the carrier ply of the hot stamping foil from the transfer ply applied to the main body, in particular where the transfer ply of the hot stamping foil remains on the main body in the stamping region.

It is additionally possible that, after the applying and/or after the cooling time has elapsed, the clamp device is raised or lowered in order to detach the carrier ply of the hot stamping foil, in particular wherein the transfer ply of the hot stamping foil remains in the stamping region on the uneven surface of the main body.

After the cooling time has elapsed, the layer thermally activated by the hot stamping die, in particular the adhesive, is at least partly cured, such that the transfer ply of the hot stamping foil has a firm bond to the main body in the decoration region.

Preferably, when the clamp device is lifted in the decoration region, the carrier ply of the hot stamping foil is detached from the applied transfer ply.

Advantageously, the hot stamping foil is curved downward after application and/or after the cooling time, i.e. curved in the direction of the holding device. This leads to an improvement in the detachment.

It may also be possible, after the applying and/or after the cooling time has elapsed, for the carrier ply of the hot stamping foil to be detached by means of a detachment rod, wherein the detachment rod is moved in vertical direction and between the carrier ply of the hot stamping foil and the main body, in particular wherein the transfer ply of the hot stamping foil remains in the stamping region on the uneven surface of the main body.

It is especially the case that the hot stamping device has a detachment rod which, for detaching of the carrier ply of the hot stamping foil from the main body, is movable in vertical direction between the carrier ply of the hot stamping foil and the main body, in particular where the transfer ply of the hot stamping foil remains on the main body in the stamping region.

Preferably, the detachment rod has a length that corresponds at least to the width of the hot stamping foil. The detachment rod preferably moves in foil direction between carrier ply of the hot stamping foil and main body and hence continuously and progressively detaches the carrier ply from the applied transfer ply. In particular, it is possible that the detachment rod is a metal rod.

The detaching of the carrier ply of the hot stamping foil by lifting the clamp device can also be combined with a detachment rod. At the same time, the detachment rod preferably also moves additionally between carrier ply of the hot stamping foil and main body after the clamp device has been lifted and hence continuously and progressively removes any remaining carrier ply of the hot stamping foil.

It is further preferably the case that the holding device is moved to its detachment position after application. The decorated main body can then be removed from the holding device. The main body is preferably removed by human hand and/or by a conveyor device that ends in the holding device, and/or in a fully automated manner, for example by a robot, in particular robot arm.

Preferably, the hot stamping device comprises a control device for controlling the hot stamping die, the clamp device, the holding device, the feeding device, the compressed air device and/or the vacuum suction, where this control device is designed, in particular suitably programmed, to control the individual steps over time. This can further reduce the cycle time.

The method and the hot stamping device for decorating an uneven surface of a main body with a transfer ply of a hot stamping foil is employed, for example, in the automotive industry, and wherever optically high-quality three-dimensional surfaces are to be provided. The described method and the described hot stamping device are capable of decorating complex three-dimensional surfaces with the transfer ply of a hot stamping foil without wrinkling or trapped air.

The invention is elucidated by way of example hereinafter by several working examples with reference to the accompanying drawings. The working examples shown should therefore not be interpreted in a restrictive manner.

FIG. 1 shows a schematic of the method steps of a method of decorating an uneven surface of a main body in a flow diagram

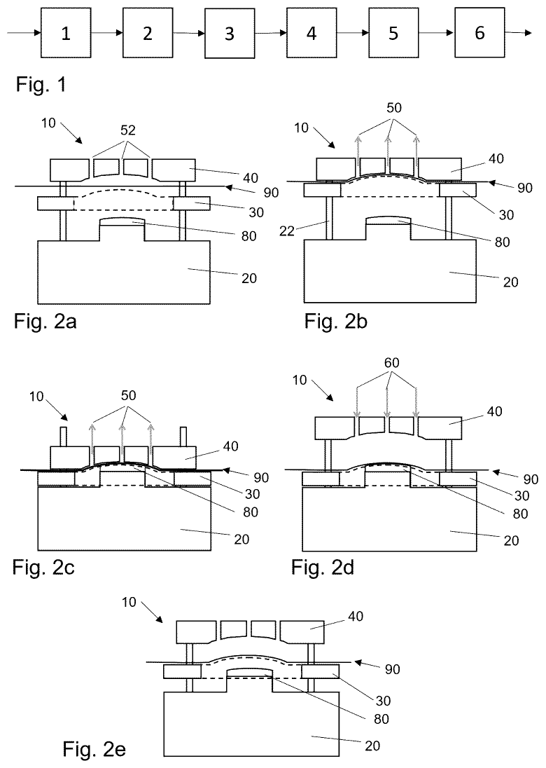

FIGS. 2a-2e show a schematic of the method steps for decorating an uneven surface of a main body

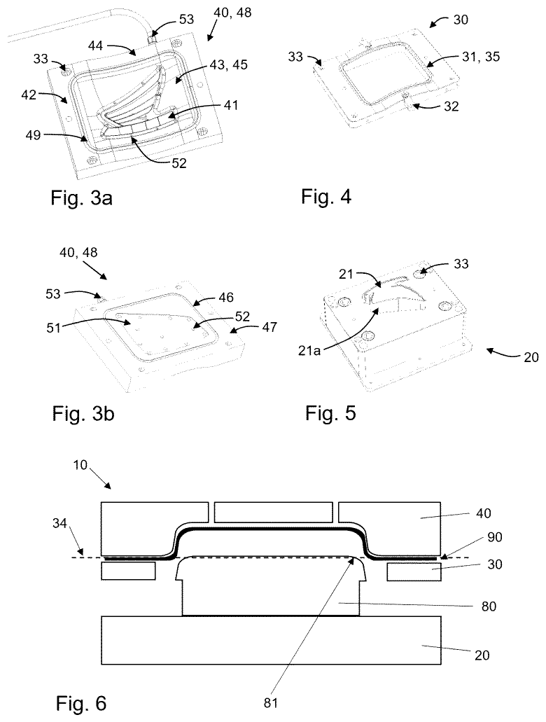

FIG. 3a shows a schematic of a hot stamping die looking at the stamping side

FIG. 3b shows a schematic of a hot stamping die looking at the back

FIG. 4 shows a schematic of a clamp device looking at the side facing the hot stamping die

FIG. 5 shows a schematic of a holding device

FIG. 6 shows a schematic of a section view of the hot stamping device

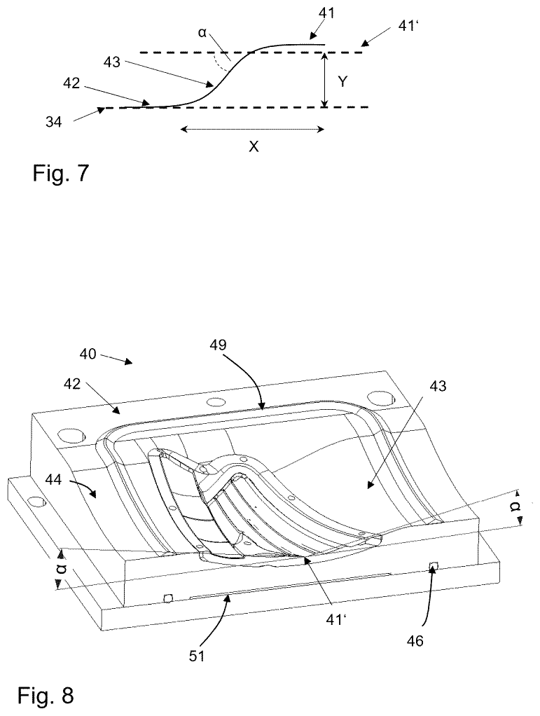

FIG. 7 shows a schematic of a stamping cavity of a hot stamping die

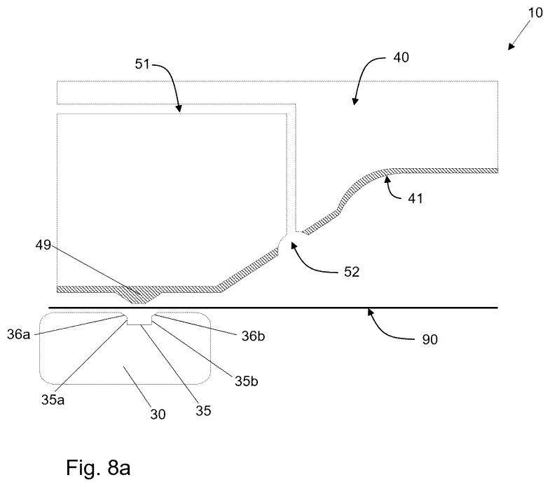

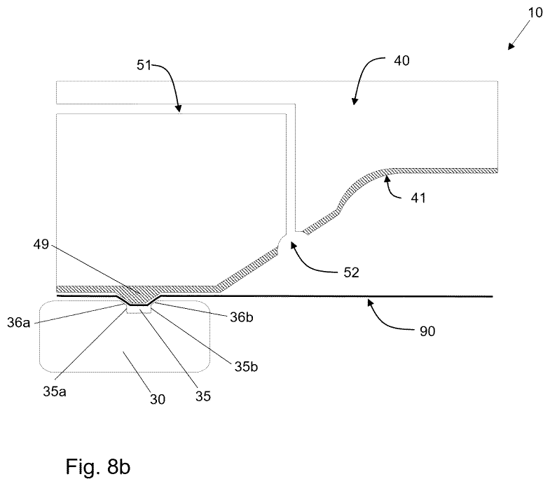

FIG. 8 shows a schematic of a three-dimensional representation of a hot stamping die in a section view, wherein the maximum permissible angle α is shown schematically

FIG. 8a shows a schematic of a detail of the hot stamping device in the region of the clamp device, with the hot stamping foil in the unclamped state

FIG. 8b shows a schematic of a detail of the hot stamping device in the region of the clamp device, with the hot stamping foil clamped

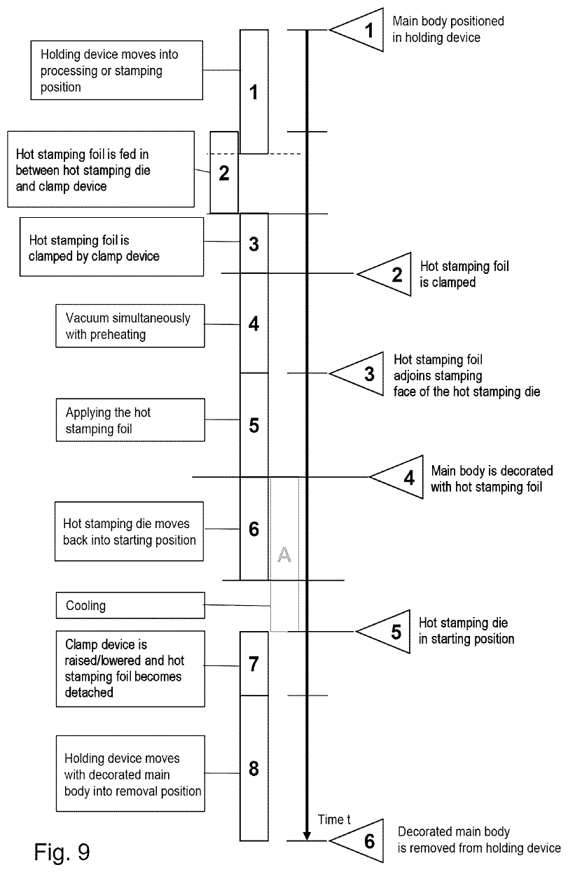

FIG. 9 shows a schematic of the method steps of a method of decorating an uneven surface of a main body in a flow diagram

FIG. 1 shows a schematic of the method steps of a method of decorating an uneven surface 81 of a main body 80 by means of a transfer ply of a hot stamping foil 90. The method involves conducting the following steps:
providing the main body 1, 80 in a holding device 20;
providing the hot stamping foil 2, 90;
clamping 3 the hot stamping foil 90 to a hot stamping die 40 by means of a clamp device 30;
sucking 4 the hot stamping foil 90 onto a stamping face 41 of the hot stamping die 40 by means of vacuum suction 50;
preheating 5 the hot stamping foil 90, in particular at least in the region of the stamping face 41 and/or in the region of a three-dimensional foil guide 45 which is preferably adjacent to the stamping face 41, by means of heated hot stamping dies 40;
applying 6 the transfer ply of the hot stamping foil 90 to an uneven surface 81 of the main body 80, in which the hot stamping foil 90 is brought into contact with the uneven surface 81 of the main body 80 and the transfer ply is transferred to the main body 80 by means of the hot stamping die 40 under the effect of stamping pressure and stamping temperature.

FIG. 2a shows a schematic of a hot stamping device 10 in which the two method steps of providing the main body 1, 80 in a holding device 20 and providing the hot stamping foil 2, 90 have already been conducted. The hot stamping foil 90 shown is hot stamping foil 90 in the form of roll material. For this purpose, it is preferably the case that the hot stamping device 10 has a feed device (not shown in FIG. 2a) which feeds the hot stamping foil 90 between the hot stamping die 40 and the clamp device 30. Such a feed device preferably has an unwinding roller for unwinding the hot stamping foil 90 and a winding roller for winding the hot stamping foil 90, where the hot stamping foil 90 is inserted and ejected between the hot stamping die 40 and the clamp device 30.

In alternative embodiments, it is possible that the hot stamping foil 90 is supplied as a foil sheet between the hot stamping die 40 and the clamp device 30.

The hot stamping device 10 shown in FIGS. 2a to 2e includes a holding device 20 for holding the main body 80 and a hot stamping die 40 with a stamping face 41 for applying 6 the transfer ply of the hot stamping foil 90 to the main body 80 and a clamp device 30 for clamping 3 the hot stamping foil 90 to the hot stamping die 40. Furthermore, the hot stamping device 10 comprises a vacuum suction 50 (not shown) for suction 4 of the hot stamping foil 90 onto the stamping face 41 and onto the adjacent three-dimensional foil guide 45 of the hot stamping die 40, with the vacuum suction 50 connected to the hot stamping die 40, and with the heated hot stamping die 40 preheating the suctioned hot stamping foil 90, in particular in the region of the stamping face 41 and in the region of the adjacent three-dimensional foil guide (45).

The hot stamping die 40 shown in FIGS. 2a to 2e has bores 52 that are used by the vacuum suction 50 for suctioning 4 of the hot stamping foil 90. In addition, these bores 52 may also be used for a compressed air device 60 (not shown).

FIG. 2b shows a schematic of the hot stamping device 10 of FIG. 2a, in which the hot stamping foil 90 is already clamped and suctioned. For this purpose, the clamp device 30 is first moved toward the hot stamping die 40, such that the hot stamping foil 90 is or has been clamped between the clamp device 30 and the hot stamping die 40. Preferably, a guide 22, in particular guide rod, is provided, along which the clamp device 30 and/or the hot stamping die 40 can move. The guide 22 or guide rod ensures that the clamp device 30 and/or the hot stamping die 40 always move in a positionally exact manner, so that no positional variances can occur in the stamping process. Preferably, for this purpose, the clamp device 30 and/or the hot stamping device 10 and/or the holding device 20 have bores 33 in which the guides are or have been held.

As soon as or shortly before the hot stamping foil 90 is clamped, the vacuum suction 50 is activated. This is shown in FIG. 2b by way of illustration by the three arrows pointing upward. The activating of the vacuum suction 50 results in suction of the hot stamping foil 90 onto the surface of the hot stamping die 40, in particular the stamping face 41, and onto the adjacent three-dimensional foil guide 45.

At the same time, the heated hot stamping die 40 preferably ensures that the hot stamping foil 90 is preheated. The hot stamping die 40 preferably preheats the hot stamping foil 90, in particular in the region of the stamping face 41 and in the region of the adjacent three-dimensional foil guide 45, for a period of time in the range from 1 s to 10 s, in particular in the range of 1 s to 5 s. Advantageously, the preheating 5 ensures that the hot stamping foil 90 becomes stretchable, such that it can more easily and accurately adapt to the contour of the stamping face 41 and to the adjacent three-dimensional foil guide 45 of the hot stamping die 40.

By means of the combination of the vacuum suction 50 and the preheating 5 by the hot stamping die 40, the adaptation of the hot stamping foil 90 to the surface of the hot stamping die 40 or the stamping face 41 and to the adjacent three-dimensional foil guide 45 of the hot stamping die 40 can be further improved. This combination avoids trapped air and wrinkling when the hot stamping foil 90 is clamped to the surface or stamping face 41 and to the adjacent three-dimensional foil guide 45 of the hot stamping die 40. This is particularly advantageous in the case of three-dimensional stamping faces 41, in particular complex three-dimensional stamping faces 41. The wrinkle-free and trapped air-free adaptation of the hot stamping foil 90 can result in a high-quality stamping outcome or clean decoration on three-dimensional or uneven surfaces.

The hot stamping foil 90 is preferably preheated 5 using the intrinsic heat of the hot stamping die 40. Thus, in the preheating 5, it is possible to dispense with other heat sources, such as a heated fan. Furthermore, the hot stamping die 40 ensures a uniform supply of heat and hence also uniform distribution of heat within the hot stamping foil 90. In other words, this means that the uniform distribution of heat results in virtually constant material properties of the hot stamping foil 90 in the preheated state essentially over the entire cross section. This also improves the adaptation of the hot stamping foil 90 to the surface or stamping face 41 and likewise to the adjacent three-dimensional foil guide 45 of the hot stamping die 40, since only few faults, if any, occur within the hot stamping foil 90 as a result of different material properties owing to uneven heat distribution.

FIG. 2c shows the applying 6 of the hot stamping foil 90 to an uneven surface 81 of the main body 80. In the example shown in FIG. 2c, the hot stamping die 40 moves together with the clamp device 30 toward the holding device 20, such that the hot stamping foil 90 comes into contact with the uneven surface 81 of the main body 80. In a further configuration, it is possible that the holding device 20 moves toward the hot stamping die 40 and the clamp device 30, such that the hot stamping foil 90 comes into contact with the uneven surface 81 of the main body 80.

In the embodiment shown in FIG. 2c, the hot stamping die 40 and the clamp device 30 move vertically along the guide 22 from a starting position (see FIG. 2b) into a stamping position (see FIG. 2c). Stamping position here means the position in which contact is or has been established between the uneven surface 81 of the main body 80 with the hot stamping foil 90.

Preferably, the hot stamping die 40 remains on the uneven surface 81 of the main body 80 for a stamping time of 0.5 second to 5 seconds, in particular from 0.5 second to 1.5 seconds, in particular where the stamping time begins at the time of the first contact between hot stamping foil 90 and the uneven surface 81 of the main body 80.

It is preferably the case that the hot stamping foil 90, during the applying 6, continues to be sucked onto to the surface of the hot stamping die 40 by the vacuum suction 50, in particular the stamping face 41, and onto the adjacent three-dimensional foil guide 45 of the hot stamping die 40. This offers the advantage that the hot stamping foil 90 continues to remain true to the contour at the stamping face 41 at all times, in order thus to improve the stamping outcome.

It is preferable that the applying 6 of the hot stamping foil 90 is effected at a stamping temperature in the range from 150° C. to 250° C., in particular in the range from 180° C. to 220° C. It may also be possible with preference that the applying 6 of the hot stamping foil 90 is effected with a stamping pressure in the range from 200 N/cm² to 370N/cm² , preferably in the range from 250 N/cm² to 300N/cm².

FIG. 2d shows how the hot stamping die 40 moves from the stamping position into its starting position after the applying 6. It is preferably the case here that the clamp device 30 still remains in the stamping position.

It is preferably the case that, before or during the moving of the hot stamping die 40 into the starting position, the hot stamping foil 90 is blown away from the hot stamping die 40 by means of a compressed air device 60, preferably under positive pressure. This is shown in FIG. 2d by the arrows pointing downward. For this purpose, the same channels and/or bores 52 in the hot stamping die 40 are preferably used by the compressed air device 60 as for the vacuum suction 50.

It is preferably the case that the compressed air device 60 detaches the hot stamping foil 90 from the hot stamping die 40 at a pressure in the range from 1.05 bar to 2 bar.

The blowing-away by means of the compressed air device 60 allows the soft, heated and mechanically unstable hot stamping foil 90 to faultlessly detach itself from the surface of the hot stamping die 40. It is thus possible to prevent cracks or faults in the decoration.

Preferably, the hot stamping die 40 is moved independently of the clamp device 30 or the clamp direction is moved together with the clamp device 30. This means that, after the applying 6, either the hot stamping die 40 moves alone or the holding device 20 and the clamp device 30 move together, such that the applied hot stamping foil 90 can first cool down.

It is preferably the case that, after the hot stamping die 40 has been moved into the starting position, the hot stamping foil 90 remains on the main body 80 for cooling for a cooling time within a range from 1 second to 5 seconds. The cooling can enable the hot stamping foil 90 to regain strength and mechanical stability, such that the carrier ply can be faultlessly detached in the subsequent step from the transfer ply of the hot stamping foil 90 applied to the main body 80, with the transfer ply of the hot stamping foil 90 remaining on the main body 80 in the region of the stamping face 41 or in the decoration region. The cooling and in particular resultant mechanical stabilization of the carrier ply and transfer ply of the hot stamping foil 90 also improves the edge decoration of the main body 80 by the transfer ply and thus enables a cleaner breakaway in the layer composite of the transfer ply, since the cooled transfer ply has a mechanical stable bond to the main body 80.

FIG. 2e shows how the clamp device 30 is then raised or moved after the cooling time has elapsed. This detaches the carrier ply in the decoration region from the main body 80 from the transfer ply applied to the uneven surface 81 of the main body 80 together with the hot stamping foil 90 surrounding the decoration region.

In an alternative configuration, it may be the case that, after the applying 6 and/or after the cooling time has elapsed, the carrier ply of the hot stamping foil 90 is detached by means of a detachment rod, wherein the detachment rod is moved in vertical direction and between the carrier ply of the hot stamping foil 90 and the main body 80, in particular wherein the transfer ply of the hot stamping foil 90 remains in the stamping region on the uneven surface 81 of the main body 80. Another possibility is combination of detachment rod and lifting of the clamp device 30.

Subsequently, the holding device 20 is preferably moved into its removal position. This is not shown. The hot stamping process can then begin anew with a new main body 80 to be decorated.

FIG. 3a shows a schematic of a die plate 48 of a hot stamping die 40, shown looking at the stamping side or stamping face 41. The hot stamping die 40 is preferably in two-part form, in which it has a heating plate and a stamping plate 48 mountable on the heating plate. Alternatively, the hot stamping die 40 may also be in one-piece form. In this case, the hot stamping die 40 preferably has integrated direct heating in the form of heating wires.

The hot stamping die 40 shown in FIG. 3a or the die plate 48 shown in FIG. 3a has a stamping face 41 that corresponds to the decoration region of the uneven surface 81 of the main body 80. The stamping face 41 is preferably a three-dimensional and/or complex three-dimensional contour, the surfaces of which in particular in some cases have many and comparatively significant changes in angle. Furthermore, it is preferably the case that the angle of all surface regions within the stamping face 41 and/or within the decoration region is at an angle of not more than 60°, preferably of not more than 50°, more preferably of not more than 45°. Such angles ensure that the hot stamping die 40 is able to apply the stamping pressure required for application in vertical direction. In the case of more inclined surfaces, the stamping pressure acting on the face would decrease to such an extent that application of the transfer ply of the hot stamping foil 90 would no longer be possible and/or there may be wrinkling in the hot stamping foil 90.

The hot stamping die 40 or the die plate 48 preferably has a foil contact face 42 that surrounds the stamping face 41 on all sides. The foil contact face 42 is that face on which the hot stamping foil 90 is clamped to the hot stamping die 40 by means of the clamp device 30. It is preferably the case that the foil contact face 42 corresponds to a flat or even shape or a cylindrical shape or a 2.5D shape. Cylindrical and 2.5D shapes mean faces that are curved about an axis. Furthermore, it is preferably the case that the opposite foil contact faces 42 are always in the same plane or at the same height. This ensures uniform and secure clamping of the hot stamping foil 90 between the foil contact face 42 of the hot stamping die 40 and the clamp device 30, in particular the sealing lip 31 of the clamp device 30 and/or the sealing lip of the hot stamping die 40. What is meant here by uniform is that the same force or pressure is applied to every point on the foil clamp.

Furthermore, the hot stamping die 40 shown in FIG. 3a or the die plate 48 shown in FIG. 3a has three-dimensional foil guides 45 in the form of intake slopes 43 that are arranged between the foil contact face 42 and the stamping face 41 and are at an angle of not more than 40°, preferably of not more than 35°, more preferably of not more than 30°. The intake slopes 43 with such flat angles ensure that the hot stamping foil 90 is not unnecessarily “stressed” in the area of the intake slopes 43. In addition, the hot stamping foil 90 adjacent to the intake slope 43 constitutes the reserve for the stamping face 41 or the decoration region. This reserve is preferably necessary so that the hot stamping foil 90 can adapt to the contours or faces, which in some cases are at significant angles of up to 60°, within the stamping face 41 or the decoration region, and sufficient foil material is still available for this adjustment. In the region of the stamping face 41, there are preferably compressions and stretches within the hot stamping foil 90 owing to the sometimes significant changes in angle, which can be compensated for by the reserve.

Preferably, the hot stamping foil 90 is guided along the foil contact face 42. For example, it may be a two-dimensional foil guide 44 or a 2.5D foil guide. In other words, in this region, the hot stamping foil 90 is not curved, or merely curved about an axis. In contrast, there is preferably a three-dimensional foil guide 45 in the region of the intake slopes 43. In other words, in this region, the hot stamping foil 90 is preferably curved, or curved about at least two axes.

As can be seen in FIG. 3a, a sealing lip 49 can protrude from the foil contact face 42 of the hot stamping die 40. In the design according to FIG. 3a shown, the sealing lip 49 is thus positioned fixedly in the hot stamping die.

In addition, the hot stamping die 40 shown in FIG. 3a and the die plate 48 shown in FIG. 3a have a connection 53 for a vacuum suction 50 and/or a compressed air device 60.

The components used for the vacuum suction 50 and/or compressed air device 60 are described further in detail hereinafter with reference to FIG. 3b. In this regard, FIG. 3b shows a schematic of the hot stamping die 40 shown from FIG. 3a and the die plate 48 shown from FIG. 3a, this time looking at the reverse side. This firstly illustrates the connection 53 already shown in FIG. 3a. It is preferably the case that the connection 53 is used both by the vacuum suction 50 and by the compressed air device 60. In an alternative configuration, the hot stamping die 40 and the die plate 48 may also have two connections 53, where the vacuum suction 50 and the compressed air device 60 are or have been each connected to one connection 53.

The hot stamping die 40 shown in FIG. 3b or the die plate 48 shown in FIG. 3b has a channel 51 which is preferably connected to the connection 53. The channel 51 in turn is preferably connected to one or more bores 52 that end on the opposite side, i.e. the stamped side. This is also shown by way of example in FIG. 3a. The bores 52 are distributed there around the stamping face 41 in the three-dimensional foil guide 45.

There is thus a continuous flow channel from the vacuum suction 50 and/or compressed air device 60 through the connection 53, the channel 51 and the bores 52, by which the hot stamping foil 90 can be sucked onto the surface of the hot stamping die 40 or the stamping face 41 and to the adjacent three-dimensional foil guide (45) of the hot stamping die 40. The hot stamping foil 90 preferably adapts to the surface or stamping face 41 and to the adjacent three-dimensional foil guide (45) of the hot stamping die 40. This adapting is additionally improved by the preheating 5 of the hot stamping foil 90 by means of the heated hot stamping die 40.

In addition, the die plate 48 preferably has a seal 46 and a contact face 47, by means of which the die plate 48 can be mounted on a heating plate (not shown). The seal 46 ensures that the flow channel delineated by the channel 51 is sealed against the heating plate and no leakage flows can occur. This ensures that the suction 4 of the hot stamping foil onto the hot stamping die 40 by means of vacuum and/or the detachment of the hot stamping foil from the hot stamping die 40 by means of compressed air can always be conducted in a procedurally reliable manner.

FIG. 4 shows a schematic of a clamp device 30 looking at the side facing the hot stamping die 40. It is preferably the case that the side of the clamp device 30 facing the hot stamping die 40 corresponds to a negative of the surface of the hot stamping die 40, in particular of the foil contact face 42 of the hot stamping die 40, such that the clamping 3 of the hot stamping foil 90 between the hot stamping die 40 and clamp device 30 follows the contour. It is preferably also the case that the clamp device is an at least partial image of the reverse side of the main body. In the example shown in FIG. 4, the surface of the clamp device 30 is designed to match the surface of the hot stamping die 40 or the die plate 48 or foil contact face 42 according to FIG. 3a.

In the clamp device 30 shown in FIG. 4, the clamp device 30 takes the form of a continuous frame with a recess larger than the main body 80. This makes it possible, on applying 6 of the hot stamping foil 90, as a result of the moving of the hot stamping die 40 together with the clamp device 30 toward the main body 80, for the main body 80 to be sunk through this recess without collision. In an alternative configuration, it may be the case that the clamp device 30 takes the form of two opposing clamping blocks with a separation greater than at least one lateral dimension of the uneven surface 81 of the main body 80.

Furthermore, the clamp device 30 shown in FIG. 4 has guide holes 33 which are configured correspondingly to the guide holes 33 of the hot stamping die 40 and the die plate 48 according to FIGS. 3a and 3b and the holding device 20 according to FIG. 5. By means of a guide 22 or guide rod (not shown), which is preferably positioned in the guide bores, the movement sequences of the hot stamping die 40, the clamp device 30 and optionally the holding device 20 can be controlled relative to one another in a positionally exact manner.

The clamp device 30 shown in FIG. 4 preferably has a sealing lip 31. Preferably, the hot stamping foil 90 is clamped between sealing lip 31 of the clamp device 30 and the foil contact face 42 of the hot stamping die 40. It is preferably therefore the case that the sealing lip 31 is formed correspondingly to the contour of the foil contact face 42 of the hot stamping die 40. The sealing lip 31 advantageously ensures that the hot stamping foil 90 cannot slip after clamping 3. The sealing lip 31 can thus assist the vacuum suction of the hot stamping die 40 by form-fitting in the fixing of the hot stamping foil 90.

Clamping 3 of the hot stamping foil 90 is preferably accomplished in that the clamp device 30 is vertically movable or moved toward the hot stamping die 40. As already described above, it is preferably the case that the hot stamping die 40, for applying 6, moves or is moved vertically together with the clamp device 30 toward the main body 80 or the holding device 20. After the hot stamping foil 90 has been applied, the hot stamping die 40 preferably first moves into its starting position. Preferably, the clamp device 30 still remains in the stamping position. For this purpose, it is preferably the case that the clamp device 30 has a holding-down means 32 by which the clamp device 30 is held in this position. A corresponding holding-down means 32 is shown in FIG. 4. When the holding-down means 32 is released, the clamp device 30 can be returned to the original position by means of a spring (not shown). In addition, other recovery mechanisms are conceivable instead of a spring.

FIG. 5 shows a schematic of a holding device 20. As already mentioned with regard to FIG. 4, the holding device 20 of FIG. 5 has guide holes 33 which are preferably congruent with the guide holes 33 of the clamp device 30 and/or the hot stamping die 40. These guide holes 33 can retain corresponding guides 22 or guide rods, along which the clamp device 30 can move vertically. The hot stamping die 40 and/or the holding device 20 is moved by means of guide elements or guide rods (not shown), which are in particular part of the hot stamping device 10.

Furthermore, the holding device 20 shown in FIG. 5 has a main body holder 21 which is preferably designed in the form of a step 21a with an indentation. This indentation preferably corresponds essentially to the negative of the main body 80, preferably in that there is an excess relative to the main body 80. This allows the main body 80 to be easily inserted into the indentation of the holding device 20. The step 21a preferably has a height corresponding at least to the thickness of the clamp device 30. In this way, in the process of moving the hot stamping die 40 together with the clamp device 30, the clamp device 30 is prevented from moving to the holding device 20.

FIG. 6 also shows a section view of the hot stamping device 10. The hot stamping device 10, as already described above, includes a holding device 20 in which a main body 80 is positioned, a clamp device 30 and a hot stamping die 40. The hot stamping foil 90 is already clamped in the example shown in FIG. 6. In addition, the hot stamping foil 90 is already suctioned onto the surface of the hot stamping die 40, in particular the stamping face 41, and onto the adjacent three-dimensional foil guide (45). The main body 80 shown has an uneven surface 81 which is to be stamped. A clamping plane 34 is preferably formed between the hot stamping die 40 and the clamp device 30, as shown, for example, by the dashed line in FIG. 6.

FIG. 7 shows a schematic of a stamping cavity of a hot stamping die 40. This in particular shows the geometrical relationships in detail. As already described above, the stamping cavity is preferably formed from the stamping face 41 and/or the three-dimensional foil guide (45) in the form of an intake slope 43 and/or the foil contact face 42. The stamping face 41 preferably constitutes the top end and the foil contact face 42 the bottom end of the cavity.

In particular, a clamping plane 34 is or has been formed between the foil contact face 42 and the surface of the clamp device 30, as shown in FIG. 7 by the lower dashed line.

The upper end of the stamping face 41′ is shown in FIG. 7 by the upper dashed line.

Furthermore, a vertical distance Y is indicated in FIG. 7, which preferably is or has been formed by the vertical distance Y between foil contact face 42, in particular the clamping plane 34, and the top end of the stamping face 41′, where this vertical distance Y is preferably at least 2 mm.

In particular, a clamping plane 34 is or has been formed between the foil contact face 42 and the surface of the clamp device 30.

It is also preferably the case that the maximum permissible angle α between the top end of the stamping face 41′ and the three-dimensional foil guide 45 or the intake slope 43 is not more than 40°.

The vertical distance Y and the maximum permissible angle α give a horizontal distance X which defines the horizontal distance X between the outermost point on the three-dimensional foil guide or the intake slope 43 and the top end of the stamping face 41′, which is at least 10 mm. The outermost point on the three-dimensional foil guide or the intake slope 43 means the point at which the three-dimensional foil guide or the intake slope 43 merges into the foil contact face 42.

For better illustration, FIG. 8 shows a three-dimensional representation of a hot stamping die 40 in a section view, with two maximum permissible angles α indicated by way of example. The two maximum permissible angles α are indicated from the top end of the stamping face 41′ the respective intake slope 43.

In addition, FIG. 8 also further illustrates the sealing lip 49 described with reference to FIG. 3a in detail. As already described with regard to FIG. 3a, the sealing lip 49 protrudes from the foil contact face 42. In the design shown in FIG. 8, the sealing lip 49 has a trapezoidal cross-sectional shape. However, it is also possible that the cross-sectional shape of the sealing lip 49 is conical or semicircular. The sealing lip 49 is preferably provided to assist foil clamping, where the sealing lip 49 preferably engages correspondingly with a groove 35 or bulge 35 in the clamp device 30. This is additionally also shown in detail in FIGS. 8a and 8b.

FIG. 8a shows a schematic of a detail of the hot stamping device 10 in the region of the clamp device 30, with the hot stamping foil 90 in the unclamped state. In this design too, the sealing lip 49 is also of trapezoidal configuration and is in a fixed arrangement in the hot stamping die 40. Moreover, the clamp device 30 has a groove 35 corresponding to the sealing lip 49. Alternatively, this may also be a bulge 35. The bulge is then preferably adapted in accordance with the shape of the sealing lip 49. As can be seen in FIG. 8a, the groove 35 has two opposite flanks 35a and 35b. Furthermore, the two opposite flanks 35a and 35b each comprise a chamfer 36a and 36b, in particular where the chamfers 36a and 36b are positioned at the opening of the groove 35 or serve as an opening of the groove 35. The chamfers 36a, 36b are preferably chosen according to the shape of the sealing lip 49. The chamfers 36a, 36b ensure that, when the hot stamping foil 90 is clamped, the sealing lip 49 can be reliably sunk into the corresponding groove 35.

FIG. 8b shows a schematic of a detail of the hot stamping device 10 in the region of the clamp device 30, with the hot stamping foil 90 clamped. As can be seen in FIG. 8b, the sealing lip 49 is now sunk into the groove 35. The hot stamping foil 90 is positioned between the sealing lip 49 and the groove 35, in particular between the sealing lip 49 and the flanks 35a, 35b and their chamfers 36a, 36b. The flanks 35a, 35b, in particular the chamfers 36a, 36b of the groove 35, make contact with the corresponding regions of the sealing lip 49 in the course of clamping, such that the hot stamping foil is clamped between the flanks 35a, 35b, in particular between the chamfers 36a, 36b, and the sealing lip 49.

FIG. 9 shows a schematic of a flow diagram of a method of decorating an uneven surface 81 of a main body 80 in a flow diagram. A time axis t is plotted, by means of which the individual method steps can be assigned by time. First, as shown by arrow 1, the main body 80 is arranged or held or clamped in the holding device 20. Subsequently, the holding device 20 moves with the main body 80 arranged therein into the machining position or stamping position, as shown in box 1. The hot stamping foil 90 is then fed between the clamp device 30 and the hot stamping die 40 (see box 2). This step can also be effected overlapping in time with the movement of the holding device 20 into machining position or stamping position, as shown by the overlaps of the two boxes 1 and 2. Subsequently, as shown in box 3, the hot stamping foil 90 is clamped by means of the clamp device 30. For this purpose, preferably, as described above, the clamp device 30 moves toward the hot stamping die 40. As indicated by arrow 2, the hot stamping foil 90 is thus clamped between the hot stamping die 40 and the clamp device 30. Subsequently, the hot stamping foil 90 is sucked onto the surface of the hot stamping die 40 by means of a vacuum and, as soon as it is in contact with the surface of the hot stamping die 40, preheated by means of the heat of the hot stamping die 40 (see box 4 and arrow 3). As shown in box 5, the hot stamping foil 90 is then applied to the uneven surface 81 of the main body 80. According to arrow 4, the main body 80 is then decorated with the hot stamping foil 90, in particular the transfer ply of the hot stamping foil 90. The hot stamping die 40 then moves back to the starting position according to box 6. It is preferably the case that the clamp device 30 still remains in the stamping position.

As soon as the hot stamping die 40 begins to move into its starting position, the cooling time, which is marked by box A, commences. During the cooling time, the hot stamping foil 90 regains its mechanical stability, and so it can preferably be detached subsequently without tearing in that the clamp device 30 is lifted or lowered according to box 7. At this time, according to arrow 5, the hot stamping die 40 is already in its starting position. Finally, the holding device 20 with the decorated main body 80 is moved into the removal position (see box 8). The decorated main body 80 is finally removed there from the holding device 20 (see arrow 6).

### LIST OF REFERENCE NUMERALS

1 providing the main body
2 providing the hot stamping foil
3 clamping
4 suctioning
5 preheating
6 applying
10 hot stamping device
20 holding device
21 main body holder
21a step of the main body holder
22 guide
30 clamp device
31 sealing lip
32 holding-down means
33 guide hole
34 clamping plane
35 groove, bulge
35a flank
35b flank
36a chamfer
36b chamfer
40 hot stamping die
41 stamping face
41′ top end of the stamping face
42 foil contact area
43 intake slope
44 two-dimensional foil guide
45 three-dimensional foil guide
46 gasket
47 contact face
48 die plate
49 sealing lip
50 vacuum suction
51 channel
52 hole
53 connection for vacuum suction and/or compressed air equipment
60 compressed air device
80 main body
81 uneven surface
90 hot stamping foil
X horizontal distance
Y vertical distance
α maximum permissible angle Listing of Claims:

1. A method of decorating an uneven surface of a main body with a transfer ply of a hot stamping foil, wherein the following steps are performed,
providing the main body in a holding device;
providing the hot stamping foil;
clamping the hot stamping foil to a hot stamping die by means of a clamp device;
sucking the hot stamping foil onto a stamping face of the hot stamping die by means of vacuum suction;
preheating the hot stamping foil by means of heated hot stamping dies;
applying the transfer ply of the hot stamping foil to an uneven surface of the main body, in which the hot stamping foil is brought into contact with the uneven surface of the main body and the transfer ply is transferred to the main body by means of the hot stamping die under the effect of stamping pressure and stamping temperature.

2. The method as claimed in claim 1, wherein
the holding device is movable, between a removal position and a processing position and/or movable between an insertion position and processing position.

3. The method as claimed in claim 2, wherein
the holding device is movable between the processing position and a stamping position, where the holding device in the stamping position is pressed onto the hot stamping die under the effect of stamping pressure.

4. The method as claimed in claim 2, wherein
the holding device is moved into the machining position or to the stamping position.

5. The method as claimed in claim 1, wherein the hot stamping die is movable between a starting position and a stamping position.

6. The method as claimed in claim 1, wherein
the stamping face of the hot stamping die corresponds to the stamping area to be stamped on the uneven surface of the main body.

7. The method as claimed in claim 1, wherein
the hot stamping die has a foil contact face that surrounds the stamping face on all sides.

8. The method as claimed in claim 7, wherein
the hot stamping die, between the foil contact face and the stamping face, has a three-dimensional foil guide in the form of an intake slope, where the intake slopes are at an angle of not more than 40°.

9. The method as claimed in claim 7, wherein
a clamping plane is formed between the foil contact face and the surface of the clamp device.

10. The method as claimed in claim 7, wherein
the foil contact face has a vertical distance from the top end of the stamping face of at least 2 mm in a plane of intersection of the hot stamping die.

11. The method as claimed in claim 7, wherein
the foil contact face corresponds to a flat shape or a cylindrical shape or a 2.5D shape.

12. The method as claimed in claims, claim 1, wherein
the clamp device has a sealing lip and/or wherein the hot stamping die has a sealing lip.

13. The method as claimed in claim 1, wherein
the hot stamping foil is guided between the clamp device and the hot stamping die.

14. The method as claimed in claim 12, wherein
the hot stamping foil is clamped between the foil contact face of the hot stamping die and the sealing lip of the clamp device or in wherein the hot stamping foil is clamped between the foil contact face of the hot stamping die and the clamp device.

15. The method as claimed in claim 1, wherein
the clamping of the hot stamping foil clamps the hot stamping foil such that it has a vertical distance of at least 2 mm from the stamping face of the hot stamping die.

16. The method as claimed in claim 1, wherein
the suction of the hot stamping foil is effected at a pressure in the range from 0.05 bar to 0.95 bar.

17. The method as claimed in claim 1, wherein
the hot stamping die preheats the hot stamping foil for a period of time in the range from 1 s to 10 s.

18. The method as claimed in claim 1, wherein
the applying contacts the hot stamping foil with the uneven surface of the main bodyin that the hot stamping die is moved onto the main body and/or the holding device is moved toward the hot stamping die.

19. The method as claimed in claim 1, wherein
the applying of the hot stamping foil involves leaving the hot stamping die on the uneven surface of the main body for a stamping time of 0.5 second to 5 seconds.

20. The method as claimed in claim 1, wherein
the hot stamping foil is applied at a stamping temperature in the range from 150 C. to 250° C.

21. The method as claimed in claim 1, wherein
the hot stamping foil is applied with a stamping pressure in the range from 200 N/cm² to 370N/cm².

22. The method as claimed in claim 1, wherein
the hot stamping die is moved into the starting position after the applying and/or the holding device is moved into the processing position after the applying.

23. The method as claimed in claim 1, wherein
before or during the moving of the hot stamping die into the starting position, the hot stamping foil is blown away from the hot stamping die by means of a compressed air device.

24. The method as claimed in claim 1, wherein after the applying, the hot stamping foil remains on the main body for a cooling time within a range from 1 second to 5 seconds.

25. The method as claimed in claim 1, wherein
after the applying and/or after the cooling time has elapsed, the clamp device is raised or lowered in order to detach a carrier ply of the hot stamping foil.

26. The method as claimed in claim 1, wherein
after the applying and/or after the cooling time has elapsed, the carrier ply of the hot stamping foil is detached by means of a detachment rod, wherein the detachment rod is moved in vertical direction and between the carrier ply of the hot stamping foil and the main body.

27. The method as claimed in claim 1, wherein
the holding device is moved into its removal position after the applying.

28-55. (canceled)
